(19) United States
(12) Patent Application Publication
(10) Pub. No.: US 2016/0277236 A1
(43) Pub. Date: Sep. 22, 2016

(54) METHOD AND APPARATUS FOR BINDING DEVICE

(71) Applicant: Xiaomi Inc., Beijing (CN)

(72) Inventors: Changbing CHEN, Beijing (CN); Shangtao Zhou, Beijing (CN); Enxing Hou, Beijing (CN)

(73) Assignee: Xiaomi Inc., Beijing (CN)

(21) Appl. No.: 15/051,175

(22) Filed: Feb. 23, 2016

(30) Foreign Application Priority Data
Mar. 16, 2015 (CN) 201510114299.8

(51) Int. Cl. H04L 12/24; H04L 29/06

(52) U.S. Cl. CPC H04L 41/0803; H04L 67/42

(57) ABSTRACT

A method and an apparatus are provided for binding a terminal with an electronic device. In the method, the server receives a binding request sent from a terminal, where the binding request includes a device identification identifying an electronic device and a user account corresponding to the terminal. The server determines whether there exists a record involving the user account and the device identification in the server. When determining that the record exists in the server, the server binds the user account and the device identification.

### CROSS-REFERENCE TO RELATED APPLICATION

This application is based upon and claims priority to Chinese Patent Application No. 201510114299.8, filed Mar. 16, 2015, the entire contents of which are incorporated herein by reference.

### TECHNICAL FIELD

The present disclosure generally relates to the technical field of computer, and more particularly, to a method and an apparatus for binding a device.

### BACKGROUND

Before using an electronic device, a user usually needs to bind the electronic device with a user account via a terminal so as to configure the electronic device as a private device of the user and thereby to provide personalized service for the user. The electronic device is the device which needs to be bound to the user account, and the terminal is the device assisting the binding between the electronic device and the user account.

The terminal may be a mobile phone and the electronic device may be a wristband, the method for binding the device includes: the mobile phone obtains a wristband identification of the wristband and a user account, and sends the wristband identification and the user account to a server; the server sends the mobile phone instruction information for instructing the user to press a key on the wristband. When the user presses the key on the wristband according to the instruction information, the server receives an operation signal which is generated and sent by the wristband according to the predetermined operations, determines that the wristband is a wristband owned by the user and binds the user account and the wristband identification.

### SUMMARY

Embodiments of the present disclosure provide a method and an apparatus for binding a device.

According to a first aspect of the present disclosure, there is provided a method for binding a device. The method is at least partially implemented in a server and includes: receiving a binding request sent from a terminal, wherein the binding request includes a device identification of an electronic device and a user account corresponding to the terminal; determining whether there exists a record involving the user account and the device identification in the server; and when determining that the record exists in the server, binding the user account and the device identification.

According to a second aspect of the present disclosure, there is provided a method for binding a device. The method is at least partially implemented in a terminal and includes: generating a binding request carrying a device identification of an electronic device and a user account corresponding to the terminal; and sending the binding request to a server, wherein the binding request is configured to instruct the server to bind the user account and the device identification when the server determines that there exists a record involving the user account and the device identification in the server.

According to a third aspect of the present disclosure, there is provided an apparatus for binding a device. The apparatus is at least partially implemented in a server and includes: a processor and a memory for storing instructions executable by the processor. The processor is configured to perform: receiving a binding request sent from a terminal, wherein the binding request includes a device identification of an electronic device and a user account corresponding to the terminal; determining whether there exists a record involving the user account and the device identification in the server. When determining that the record exists, the apparatus binds the user account and the device identification.

According to a fourth aspect of the present disclosure, there is provided an apparatus for binding a device. The apparatus is at least partially implemented in a terminal and includes: a processor and a memory for storing instructions executable by the processor. The processor is configured to perform: generating a binding request carrying a device identification of an electronic device and a user account corresponding to the terminal; and sending the binding request to a server, wherein the binding request is configured to instruct the server to bind the user account and the device identification when the server determines that there exists a record involving the user account and the device identification in the server.

According to a fifth aspect of the present disclosure, there is provided a non-transitory computer-readable storage medium having stored therein instructions that, when executed by a processor of a server, causes the server to perform a method for binding a device, the method including: receiving a binding request sent from a terminal, wherein the binding request comprises a device identification of an electronic device and a user account corresponding to the terminal; determining whether there exists a record involving the user account and the device identification in a record database accessible to the server; and when there exists a record involving the user account and the device identification in the record database, binding the user account and the device identification.

According to a sixth aspect of the present disclosure, there is provided a non-transitory computer-readable storage medium having stored therein instructions that, when executed by a processor of a terminal, causes the terminal to perform a method for binding a device, the method including: generating a binding request carrying a device identification of an electronic device and a user account corresponding to the terminal; and sending the binding request to a server, wherein the binding request is configured to instruct the server to bind the user account and the device identification when the server determines that there exists a record involving the user account and the device identification in the server.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart showing a method for binding a device according to an exemplary embodiment.

FIG. 2 is a flowchart showing a method for binding a device according to an exemplary embodiment.

FIG. 3A is a flowchart showing a method for binding a device according to another exemplary embodiment.

FIG. 3B is a diagram illustratively showing logging in of a user account according to another exemplary embodiment.

FIG. 3C is a diagram illustratively showing connection procedure of an electronic device according to another exemplary embodiment.

FIG. 3D is a diagram illustratively showing a successful connection of an electronic device according to another exemplary embodiment.

FIG. 3E is a diagram illustratively showing a binding prompt of an electronic device according to another exemplary embodiment.

FIG. 3F is a diagram illustratively showing a successful binding of an electronic device according to another exemplary embodiment.

FIG. 4 is a block diagram showing an apparatus for binding a device according to an exemplary embodiment.

FIG. 5 is a block diagram showing an apparatus for binding a device according to an exemplary embodiment.

FIG. 6 is a block diagram showing an apparatus for binding a device according to an exemplary embodiment.

FIG. 7 is a block diagram showing an apparatus for binding a device according to an exemplary embodiment.

FIG. 8 is a block diagram showing an apparatus for binding a device according to an exemplary embodiment.

FIG. 9 is block diagram showing an apparatus for binding a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

FIG. 1 is a flowchart showing a method for binding a device according to an exemplary embodiment. The method for binding a device is at least partially implemented in a server. As shown in FIG. 1, the method for binding a device includes the following steps.

In step 101, the server receives a binding request sent from a terminal. The binding request may include a device identification identifying an electronic device and a user account corresponding to the terminal. The electronic device to be bound may include a wristband, a headset, a smart watch, or any electronic device includes communication circuitry configured to transmit and receive certain communication signals for binding.

In step 102, the server determines whether there exists a record involving the user account and the device identification. The record may include a redemption record, a shopping record, a search record, an invoice, or any other transactions made through the online market place using the user account. The server may need to load transactions stored in a separate database to determine whether there exists a record in the stored transactions. When the record includes a redemption record, the record may include the rewarding points in the redemption, the remaining balance of the user account, the device identification, etc. The record may be stored in a record database accessible to the server.

In step 103, when there exists a record involving the user account and the device identification in the server, the server binds the user account and the device identification. For example, the server may establish a binding relationship between the user account and the device identification so that the terminal may perform predetermined operations to the electronic device. Alternatively or additionally, when there is a binding relationship between the user account and the device identification, the electronic device may cause the terminal to perform additional operations.

In summary, in the method for binding a device provided by the present disclosure, the binding request includes a device identification of an electronic device to be bound and a user account corresponding to the terminal; whether there exists a record involving the user account and the device identification in the server is determined; and when there exists a record involving the user account and the device identification in the server, the user account and the device identification are bound to each other. Thus, whether a user owns an electronic device may be determined according to whether there exists a record involving the user account and the device identification in the server, and thereby the present disclosure may solve the problem that whether an electronic device is an electronic device owned by a user is determined according to operations performed on the electronic device by the user and thus the binding procedure is cumbersome and the efficiency is low. Consequently, the efficiency for binding a device is improved.

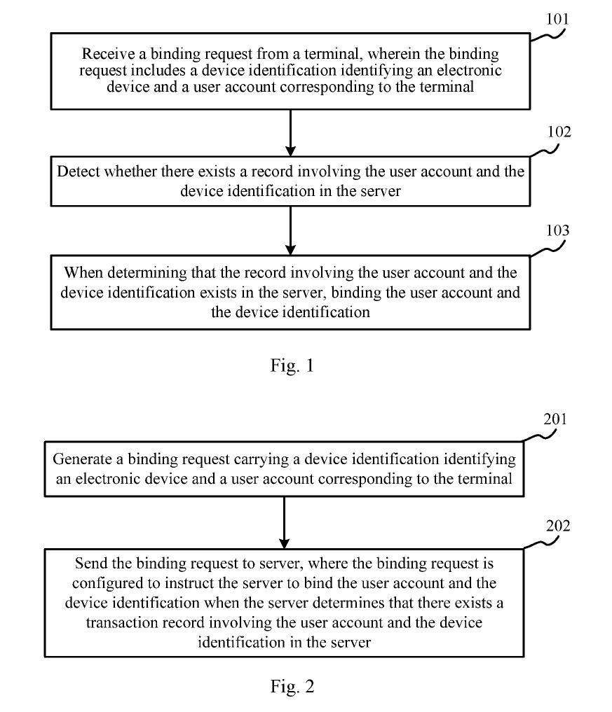

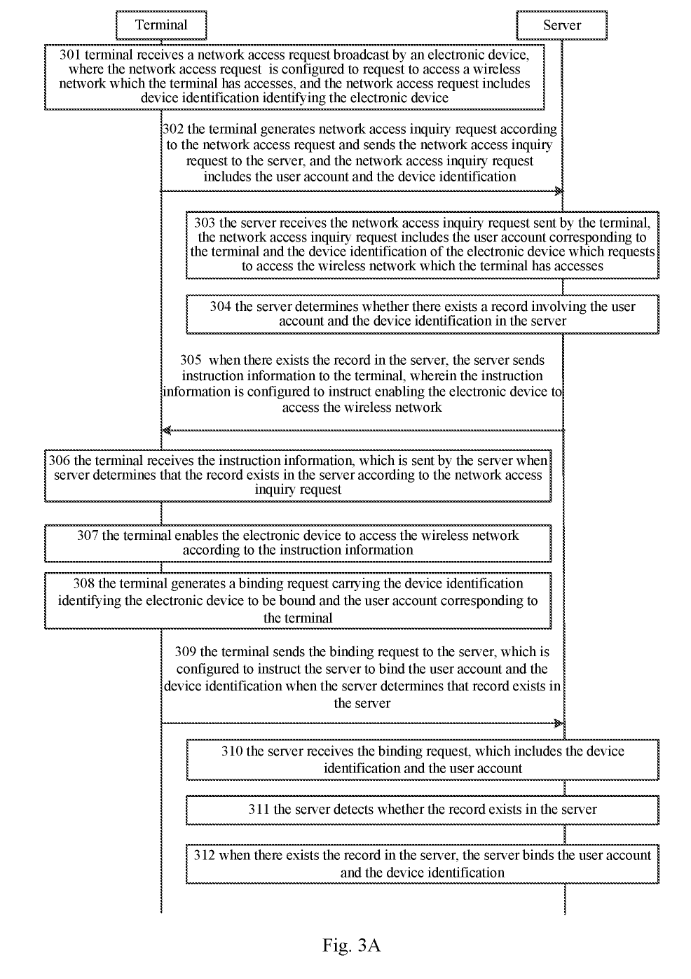

FIG. 2 is a flowchart showing a method for binding a device according to an exemplary embodiment. The method for binding a device is at least partially implemented in a terminal. As shown in FIG. 2, the method for binding a device includes the following steps.

In step 201, the terminal generates a binding request carrying a device identification identifying an electronic device and a user account corresponding to the terminal. For example, the terminal may obtain the device identification by scanning the bard code on the package of the electronic device. The terminal may obtain the device identification by scanning the device identification on a receipt shipped with the electronic device.

In step 202, the terminal sends the binding request to a server. The binding request is configured to instruct the server to bind the user account and the device identification when the server determines that there exists a record involving the user account and the device identification in the server.

In summary, in the method for binding a device provided by the present disclosure, a binding request carrying a device identification of an electronic device to be bound and a user account corresponding to the terminal is generated, and the binding request is sent to a server. The binding request is configured to instruct the server to bind the user account and the device identification when the server determines that there exists a record involving the user account and the device identification in the server. Thus, whether a user owns an electronic device may be determined according to whether there exists a record involving the user account and the device identification in the server, and thereby the present disclosure may solve the problem that whether an electronic device is an electronic device owned by a user is determined according to operations performed on the electronic device by the user and thus the binding procedure is cumbersome and the efficiency is low. Consequently, the efficiency for binding a device is improved.

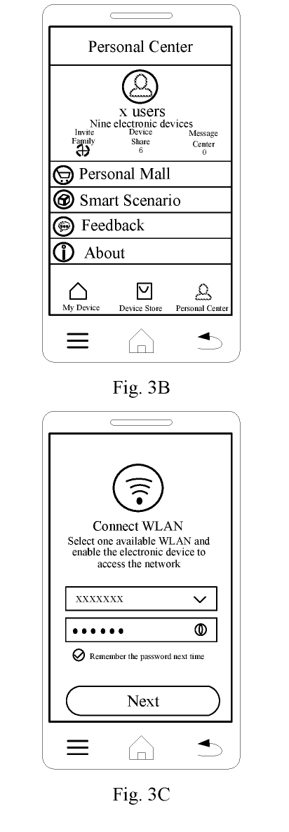

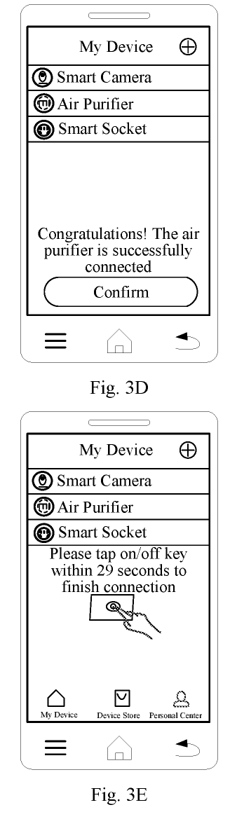

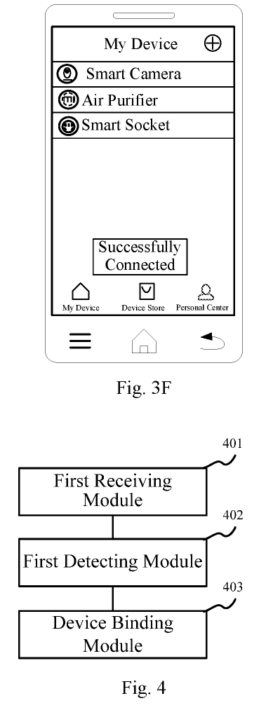

FIG. 3A is a flowchart showing a method for binding a device according to another exemplary embodiment. The method for binding a device is at least partially implemented in a system including a server and a terminal. As shown in FIG. 3A, the method includes the following steps.

In step 301, a terminal receives a network access request broadcast by an electronic device to be bound. The network access request is configured to request to access a wireless network which the terminal has accesses, and the network access request includes a device identification of the electronic device.

After power-on of the electronic device, the electronic device may broadcast a network access request externally to request to access a wireless network which the terminal has accesses.

The electronic device in this step may be an electronic device which is redeemed by a user via a user account, or may not be the electronic device which is redeemed by the user via the user account, for example, may be an electronic device which is given to the user by another user, and the present disclosure does not impose specific limitations on this. The user account is an account which is assigned for the user by the server according to user information carried in an account application request after the user sends the account application request to the server. The user information includes information such as nickname, birthday or career.

The user may employ one of the following two approaches to redeem the electronic device. The user may use virtual currency, reward points, or other payment methods to redeem the electronic device. Following are two examples.

A first approach is that the user redeems the electronic device via the terminal. At this time, the user may log into the user account in a redemption client installed in the terminal or a browser, and then redeem the electronic device via the user account which is logged into. Taking the redemption client as an example, referring to FIG. 3B which schematically shows the logging in of the user account, a user may tap a “Device Store” option in a page of the redemption client, and redeem an electronic device from the “Device Store.” The redemption procedure includes: the terminal presents device description information of various electronic devices supplied by the server, when a user needs to redeem a certain electronic device, the terminal selects the electronic device and generates a redemption instruction which includes a device type of the electronic device which the user selects to redeem; the terminal generates a redemption request carrying the device type and the user account, sends the redemption request to the server; the server generates a redemption order according to the redemption request, and instructs a third party to send the electronic device to the user according to the redemption order; the third party selects one electronic device from electronic devices of the device type as indicated in the redemption order, and sends the electronic device to the user.

A second approach is that a user redeems the electronic device by another terminal. For example, the terminal is a mobile phone and another terminal is a computer. The user may log into the user account in the redemption client installed in the computer or a browser, and then redeem an electronic device via the user account which is logged into. The procedure for redeeming an electronic device by another terminal is the same with the procedure for redeeming an electronic device by the terminal, and detailed descriptions thereof are omitted.

In step 302, the terminal generates a network access inquiry request according to the network access request and sends the network access inquiry request to the server. The network access inquiry request includes the user account and the device identification.

The terminal may directly connect the electronic device to a wireless network, referring to FIG. 3C which illustratively shows a connection procedure of an electronic device, and in which the wireless network is a Wireless Local Area Network (WLAN) for example. The terminal prompts a user to input the name and the password of the WLAN in a display interface; or, when the user input the name and the password of the WLAN through the terminal in the past, the terminal prompts the user to select the name and the password of the WLAN in the display interface. For example, in FIG. 3C, the name is “xxxxxxx”, and the password is “ . . . ” Referring to FIG. 3D which is a diagram illustratively showing a successful connection of an electronic device, the electronic device is an air purifier for example, and after the air purifier is successfully connected to the wireless network, the terminal displays prompt information “Congratulations! The air purifier is successfully connected” in the display interface. After the electronic device accesses the wireless network, step 308 is performed.

In order to avoid that the terminal enables an electronic device which does not belong to the user to access the wireless network to cause the wireless network stolen, the terminal may determine whether the electronic device is owned by the user before enabling the electronic device to access the wireless network, and thereby determine whether to enable the electronic device to access the wireless network according to the determination result.

In the present embodiment, an approach for determining whether an electronic device is owned by a user may include determining whether there exists a record involving the user account and the device identification in the server. When there exists a record involving the user account and the device identification in the server, the terminal determines that the electronic device is owned by the user; when there does not exist a record involving the user account and the device identification in the server, the terminal cannot determine whether the electronic device is owned by the user. The user account is a user account corresponding to the terminal, which includes a login user account which is logged into in the terminal or a login user account which is input into the terminal by a user.

The record involving the user account and the device identification is stored by the server when the user redeems the electronic device via the user account. For example, the server may obtain from a third party the device identification sent to the user account to establish a record. Thus, the terminal may generate a network access inquiry request carrying the user account and the device identification, and send the network access inquiry request to the server so that the server may feedback instructions regarding whether to enable the electronic device to access the wirelesses network according to the network access inquiry request.

In step 303, the server receives the network access inquiry request sent by the terminal. The network access inquiry request includes the user account corresponding to the terminal and the device identification of the electronic device which requests to access a wireless network. The wireless network may be a network which the terminal has accesses.

In step 304, the server determines whether there exists a record involving the user account and the device identification in the server.

The server may read out the user account in the network access inquiry request, search the device identification corresponding to the user account in the record, and determine whether the searched device identification is the same with the received device identification; when the searched device identification is same with the received device identification, the server determines that there exists a record involving the user account and the device identification in the server; when the searched device identification is different from the received device identification, the server determines that there does not exist a record involving the user account and the device identification in the server. Or, the server may read out the device identification in the network access inquiry request, search the user account corresponding to the device identification in the record, and determine whether the searched user account is the same with the received user account; when the searched user account is the same with the received user account, the server determines that there exists a record involving the user account and the device identification in the server; when the searched user account is different from the received user account, the server determines that there does not exist a record involving the user account and the device identification in the server. Rather, the server may determine whether there exists a record involving the user account and the device identification in the server by other manners, and the present embodiment does not impose specific limitations on this.

In step 305, when there exists a record involving the user account and the device identification in the server, the server sends instruction information to the terminal. The instruction information is configured to instruct enabling the electronic device to access the wireless network.

For example, the instruction information may be as follows: the electronic device xx which you redeemed on the date of xx-xx is around you, and please start to connect this electronic device.

When the server determines that there does not exist a record involving the user account and the device identification in the server, the server may send to the terminal prompt information indicating that there does not exist a record involving the user account and the device identification in the server, so that the user may determine whether to connect the electronic device to the network according to the prompt information. When the user determines to connect the electronic device to the network, step 308 is performed. At this time, for the procedure for the terminal connecting the electronic device to the wireless network, refer to descriptions regarding FIGS. 3C and 3D and step 302, and detailed description is omitted here.

In step 306, the terminal receives the instruction information sent by the server. The instruction information is sent by the server when the server determines that there exists a record involving the user account and the device identification in the server according to the network access inquiry request.

In step 307, the terminal enables the electronic device to access the wireless network according to the instruction information.

For the procedure for the terminal enabling the electronic device to access the wireless, refer to the descriptions regarding FIGS. 3C and 3D and step 302, and detailed description is omitted.

In step 308, the terminal generates a binding request carrying the device identification identifying the electronic device to be bound and the user account corresponding to the terminal.

In the embodiment, the terminal may generate a binding request for requesting to bind the electronic device and the user account.

In a possible implementation, the binding request includes the device identification and the user account. In another possible implementation, the binding request includes other information regarding the electronic device in addition to the device identification and the user account. The other information may be information which is obtained during enabling the electronic device to access the wireless network via the terminal, for example, the name, description information and address information of the electronic device and the like, and the present disclosure does not impose specific limitations on this.

Additionally or alternatively, when the terminal has a function of recording the determination result about whether there exists a record involving the user account and the device identification in the server, the terminal may add the determination result into the binding request.

In step 309, the terminal sends the binding request to the server, which is configured to instruct the server to bind the user account and the device identification when the server determines that record exists in the server. For example, the terminal may send the binding request to the server. The binding request is configured to instruct the server to bind the user account and the device identification when the server determines that there exists a record involving the user account and the device identification in the server.

In step 310, the server receives the binding request, which includes the device identification and the user account. For example, the server may receive the binding request sent from the terminal. The binding request includes the device identification identifying the electronic device to be bound and the user account corresponding to the terminal.

In step 311, the server detects whether the record exists in the server. For example, the server determines whether there exists a record involving the user account and the device identification in the server.

When the binding request only includes the user account and the device identification, for the procedure in which the server determines whether there exists a record involving the user account and the device identification in the server, refer to the description regarding step 304 and detailed description is omitted. When the binding request includes the determination result in addition to the user account and the device identification, the server may read out the determination result in the binding request, and determine whether there exists a record involving the user account and the device identification in the server according to the determination result.

Additionally or alternatively, when the binding request further includes other information regarding the electronic device, the server may determine, according to the other information, whether the electronic device is enabled to access the wireless network with the assistance of the user account. When the electronic device is enabled to access the wireless network with the assistance of the user account and there exists a record involving the user account and the device identification in the server, step 312 is performed; when the electronic device is enabled to access the wireless network without the assistance of the user account or there does not exist a record involving the user account and the device identification in the server, the server sends to the terminal instruction information for instructing the user to perform predetermined operations on the electronic device, the user performs the predetermined operations on the electronic device according to the instruction information; at this time, the server receives an operation signal which is generated and sent by the electronic device according to the predetermined operations, determines that the electronic device is owned by the user, and binds the user account and the device identification. Referring to FIG. 3E, which is a diagram illustratively showing the binding prompt of the electronic device, the prompt information may be: please tap on/off key within 29 seconds to finish connection.

In step 312, when there exists a record involving the user account and the device identification in the server, the server binds the user account and the device identification.

The server establishes a binding relationship between the user account and the device identification. The binding relationship indicates that the user account and the device identification are in a binding state. Referring to FIG. 3F, which is a diagram illustratively showing a successful binding of the electronic device, after the binding relationship between the user account and the device identification is established in the server, the server sends the prompt information “The connection is successful” to the terminal.

In summary, in the method for binding a device provided by the present disclosure, a binding request includes a device identification of an electronic device to be bound and a user account corresponding to a terminal; whether there exists a record involving the user account and the device identification in the server is determined; and when there exists a record involving the user account and the device identification in the server, the user account and the device identification are bound to each other. Thus, whether a user owns an electronic device may be determined according to whether there exists a record involving the user account and the device identification in the server, and thereby the present disclosure may solve the problem that whether an electronic device is an electronic device owned by a user is determined according to operations performed on the electronic device by the user and thus the binding procedure is cumbersome and the efficiency is low. Consequently, the efficiency for binding a device is improved.

Further, whether there exists a record involving the user account and the device identification in the server is determined; when there exists a record involving the user account and the device identification in the server, instruction information is sent to the terminal, and the instruction information is configured to instruct the user to enable the electronic device to access the wireless network. Thus, it can be guaranteed that the electronic device which accesses the wireless network is an electronic device owned by the user. Consequently, the problem that electronic devices of other users access the wireless network can be avoided, and thereby network access accuracy is improved.

FIG. 4 is a block diagram showing an apparatus for binding a device according to an exemplary embodiment. The apparatus for binding a device is at least partially implemented in a server. As shown in FIG. 4, the apparatus includes a first receiving module 401, a first determining module 402 and a device binding module 403.

The first receiving module 401 is configured to receive a binding request sent from a terminal. The binding request includes a device identification of an electronic device to be bound and a user account corresponding to the terminal.

The first determining module 402 is configured to determine whether there exists in the server a record involving the user account and the device identification received by the first receiving module.

The device binding module 403 is configured to, when there exists a record involving the user account and the device identification in the server, bind the user account and the device identification.

In summary, in the apparatus for binding a device provided by the present disclosure, the binding request includes a device identification of an electronic device to be bound and a user account corresponding to the terminal; whether there exists a record involving the user account and the device identification in the server is determined; and when there exists a record involving the user account and the device identification in the server, the user account and the device identification are bound to each other. Thus, whether a user owns an electronic device may be determined according to whether there exists a record involving the user account and the device identification in the server, and thereby the present disclosure may solve the problem that whether an electronic device is an electronic device owned by a user is determined according to operations performed on the electronic device by the user and thus the binding procedure is cumbersome and the efficiency is low. Consequently, the efficiency for binding a device is improved.

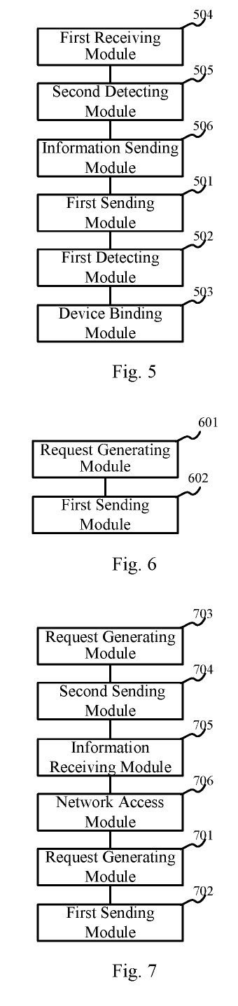

FIG. 5 is a block diagram showing an apparatus for binding a device according to an exemplary embodiment. The apparatus for binding a device may be at least partially implemented in a server, as shown in FIG. 5, the apparatus includes a first receiving module 501, a first determining module 502 and a device binding module 503.

The first receiving module 501 is configured to receive a binding request sent from a terminal. The binding request includes a device identification of an electronic device to be bound and a user account corresponding to the terminal.

The first determining module 502 is configured to determine whether there exists in the server a record involving the user account and the device identification received by the first receiving module 501.

The device binding module 503 is configured to, when there exists a record involving the user account and the device identification in the server, bind the user account and the device identification.

Additionally or alternatively, the apparatus provided in the embodiment further includes a second receiving module 504, a second determining module 505 and an information sending module 506.

The second receiving module 504 is configured to, before the first receiving module 501 receives the binding request sent by the terminal, receive a network access inquiry request sent from the terminal, wherein the network access inquiry request includes the user account corresponding to the terminal and the device identification of the electronic device which requests to access a wireless network, and the wireless network is a network which the terminal has accesses.

The second determining module 505 is configured to determine whether there exists in the server a record involving the user account and the device identification received by the second receiving module 504.

The information sending module 506 is configured to, when there exists a record involving the user account and the device identification in the server, send instruction information to the terminal, wherein the instruction information is configured to instruct enabling the electronic device to access the wireless network so that the terminal generates and sends the binding request.

Additionally or alternatively, the record involving the user account and the device identification is stored by the server when a user redeems the electronic device via the user account.

Additionally or alternatively, the user account corresponding to the terminal includes a login user account which is logged into in the terminal or a login user account which is input into the terminal by a user.

Additionally or alternatively, the device identification of the electronic device to be bound is obtained by the terminal according to a network access request broadcast by the electronic device to be bound.

In summary, in the apparatus for binding a device provided by the present disclosure, the binding request includes a device identification of an electronic device to be bound and a user account corresponding to the terminal; whether there exists a record involving the user account and the device identification in the server is determined; and when there exists a record involving the user account and the device identification in the server, the user account and the device identification are bound to each other. Thus, whether a user owns an electronic device may be determined according to whether there exists a record involving the user account and the device identification in the server, and thereby the present disclosure may solve the problem that whether an electronic device is an electronic device owned by a user is determined according to operations performed on the electronic device by the user and thus the binding procedure is cumbersome and the efficiency is low. Consequently, the efficiency for binding a device is improved.

Further, whether there exists a record involving the user account and the device identification in the server is determined; when there exists a record involving the user account and the device identification in the server, instruction information is sent to the terminal, and the instruction information is configured to instruct the user to enable the electronic device to access the wireless network. Thus, it can be guaranteed that the electronic device which accesses the wireless network is an electronic device owned by the user. Consequently, the problem that electronic devices of other users access the wireless network can be avoided, and thereby network access accuracy is improved.

FIG. 6 is a block diagram showing an apparatus for binding a device according to an exemplary embodiment. The apparatus for binding a device is at least partially implemented in a terminal. As shown in FIG. 6, the apparatus includes a request generating module 601 and a first sending module 602.

The request generating module 601 is configured to generate a binding request carrying a device identification of an electronic device to be bound and a user account corresponding to the terminal.

The first sending module 602 is configured to send the binding request generated by the request generating module 601 to a server, wherein the binding request is configured to instruct the server to bind the user account and the device identification when the server determines that there exists a record involving the user account and the device identification in the server.

In summary, in the apparatus for binding a device provided by the present disclosure, a binding request carrying a device identification of an electronic device to be bound and a user account corresponding to the terminal is generated, and the binding request is sent to a server. The binding request is configured to instruct the server to bind the user account and the device identification when the server determines that there exists a record involving the user account and the device identification in the server. Thus, whether a user owns an electronic device may be determined according to whether there exists a record involving the user account and the device identification in the server, and thereby the present disclosure may solve the problem that whether an electronic device is an electronic device owned by a user is determined according to operations performed on the electronic device by the user and thus the binding procedure is cumbersome and the efficiency is low. Consequently, the efficiency for binding a device is improved.

FIG. 7 is a block diagram showing an apparatus for binding a device according to an exemplary embodiment. The apparatus for binding a device is at least partially implemented in a terminal. As shown in FIG. 7, the apparatus includes a request generating module 701 and a first sending module 702.

The request generating module 701 is configured to generate a binding request carrying a device identification of an electronic device to be bound and a user account corresponding to the terminal.

The first sending module 702 is configured to send the binding request generated by the request generating module 701 to a server, wherein the binding request is configured to instruct the server to bind the user account and the device identification when the server determines that there exists a record involving the user account and the device identification in the server.

Additionally or alternatively, the apparatus provided by the embodiment further includes a request receiving module 703, a second sending module 704, an information receiving module 705 and a network access module 706.

The request receiving module 703 is configured to, before the request generating module 701 generates the binding request carrying the device identification of the electronic device to be bound and the user account corresponding to the terminal, obtain a network access request broadcast by the electronic device to be bound, wherein the network access request is configured to request to access a wireless network which the terminal has accesses, and the network access request includes the device identification of the electronic device.

The second sending module 704 is configured to generate a network access inquiry request according to the network access request received by the request receiving module 703 and send the network access inquiry request to the server, wherein the network access inquiry request includes the user account and the device identification.

The information receiving module 705 is configured to receive instruction information sent by the server, wherein the instruction information is sent by the server when the server determines that there exists a record involving the user account and the device identification in the server according to the network access inquiry request sent by the second sending module 704.

The network access module 706 is configured to enable the electronic device to access the wireless network according to the instruction information received by the information receiving module 705.

Additionally or alternatively, the record involving the user account and the device identification is stored by the server when a user redeems the electronic device via the user account.

Additionally or alternatively, the user account corresponding to the terminal includes a login user account which is logged into in the terminal or a login user account which is input into the terminal by a user.

In summary, in the apparatus for binding a device provided by the present disclosure, a binding request carrying a device identification of an electronic device to be bound and a user account corresponding to the terminal is generated, and the binding request is sent to a server. The binding request is configured to instruct the server to bind the user account and the device identification when the server determines that there exists a record involving the user account and the device identification in the server. Thus, whether a user owns an electronic device may be determined according to whether there exists a record involving the user account and the device identification in the server, and thereby the present disclosure may solve the problem that whether an electronic device is an electronic device owned by a user is determined according to operations performed on the electronic device by the user and thus the binding procedure is cumbersome and the efficiency is low. Consequently, the efficiency for binding a device is improved.

Further, a network access inquiry request is generated according to a network access request and the network access inquiry request is sent to a server. Instruction information sent by the server is received. The instruction information is sent by the server when the server determines that there exists a record involving the user account and the device identification in the server according to the network access inquiry request. The electronic device is enabled to access the wireless network according to the instruction information, and thus it can be guaranteed that the electronic device which accesses the wireless network is an electronic device owned by the user. Consequently, the problem that electronic devices of other users access the wireless network can be avoided, and thereby network access accuracy is improved.

As for the above apparatus embodiments, specific operation performed by each module is described in related method embodiments, and thus detailed description is omitted here.

An exemplary embodiment of the present disclosure provides an apparatus for binding a device which is capable of realizing the method for binding a device provided in the present disclosure. The apparatus for binding a device is at least partially implemented in a server and includes: a processor; and a memory for storing instructions executable by the processor. The processor is configured to perform following acts including:

receiving a binding request sent from a terminal, wherein the binding request includes a device identification identifying an electronic device and a user account corresponding to the terminal;

determining whether there exists a record involving the user account and the device identification in the server; and

when there exists a record involving the user account and the device identification in the server, binding the user account and the device identification.

An exemplary embodiment of the present disclosure provides an apparatus for binding a device which is capable of realizing the method for binding a device provided in the present disclosure. The apparatus for binding a device is at least partially implemented in a terminal and includes: a processor; and a memory for storing instructions executable by the processor. The processor is configured to perform acts including: generating a binding request carrying a device identification of an electronic device to be bound and a user account corresponding to the terminal; and sending the binding request to a server, wherein the binding request is configured to instruct the server to bind the user account and the device identification when the server determines that there exists a record involving the user account and the device identification in the server.

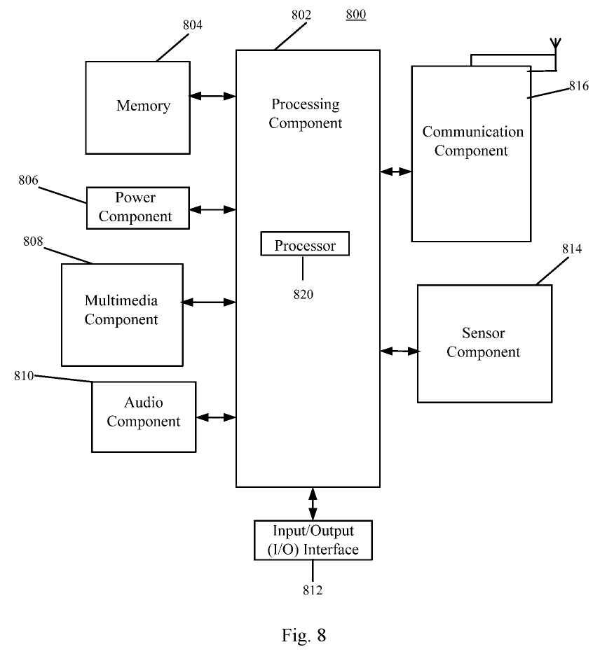

FIG. 8 is a block diagram of an apparatus 800 for binding a device according to an exemplary embodiment. For example, the apparatus 800 may be a mobile phone, a computer, a digital broadcast terminal, a messaging device, a gaming console, a tablet, a medical device, exercise equipment, a personal digital assistant, and the like.

Referring to FIG. 8, the apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the apparatus 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the apparatus 800. The power component 806 may include a power management system, one or more power sources, and any other components associated with the generation, management, and distribution of power in the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the apparatus 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may determine an open/closed status of the apparatus 800, relative positioning of components, e.g., the display and the keypad, of the apparatus 800, a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 814 may include a proximity sensor configured to determine the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the apparatus 800 and other devices. The apparatus 800 can access a wireless network based on a communication standard, such as WiFi, 2G; or 3G; or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In one or more exemplary embodiments, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods. Each module discussed above, such as the first receiving module 401, the first determining module 402 and the device binding module 403, may take the form of a packaged functional hardware unit designed for use with other components, a portion of a program code (e.g., software or firmware) executable by the processor 820 or the processing circuitry that usually performs a particular function of related functions, or a self-contained hardware or software component that interfaces with a larger system, for example.

In exemplary embodiments, there is also provided a non-transitory computer-readable storage medium including instructions, such as included in the memory 804, executable by the processor 820 in the apparatus 800, for performing the above-described methods. For example, the non-transitory computer-readable storage medium may be a ROM, a RAM, a CD-ROM, a magnetic tape, a floppy disc, an optical data storage device, and the like.

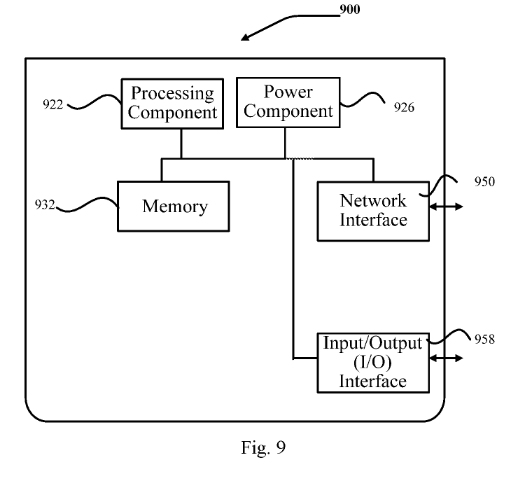

FIG. 9 is a block diagram of an apparatus 900 for binding a device according to an exemplary embodiment. For example, the apparatus 900 may be provided as a server. Referring to FIG. 9, the apparatus 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform the above described method for binding a device.

The apparatus 900 may also include a power component 926 configured to perform power management of the apparatus 900, wired or wireless network interface(s) 950 configured to connect the device 900 to a network, and an input/output (I/O) interface 958. The apparatus 900 may operate based on an operating system stored in the memory 932, such as Windows Server™, Mac OS X, Unix, Linux, FreeBSD™, or the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method, comprising:
receiving, by a server comprising a processor, a binding request sent from a terminal, wherein the binding request comprises a device identification identifying an electronic device and a user account corresponding to the terminal;
determining whether there exists a record involving the user account and the device identification in the server; and
when determining that the record exists in the server, binding the user account and the device identification.

2. The method according to claim 1, wherein before receiving the binding request sent from the terminal, the method further comprises:
receiving a network access inquiry request sent from the terminal, wherein the network access inquiry request comprises the user account corresponding to the terminal and the device identification of the electronic device which requests to access a wireless network, and the wireless network is a network which the terminal has accesses;
determining whether there exists a record involving the user account and the device identification in the server; and
when there exists a record involving the user account and the device identification in the server, sending instruction information to the terminal, wherein the instruction information is configured to instruct enabling the electronic device to access the wireless network so that the terminal generates and sends the binding request.

3. The method according to claim 1, further comprising:
storing, by the server, the record when a user conducts a redemption involving the electronic device and the user account.

4. The method according to claim 1, wherein the user account comprises a login user account that is logged into in the terminal.

5. The method according to claim 1, wherein the user account comprises a login user account that is input into the terminal by a user.

6. The method according to claim 1, wherein the device identification of the electronic device is obtained by the terminal according to a network access request broadcast by the electronic device.

7. An apparatus, comprising:
a processor; and
a memory for storing transactions;
wherein the processor is configured to perform:
receiving a binding request sent from a terminal, wherein the binding request comprises a device identification identifying an electronic device and a user account corresponding to the terminal;
determining whether there exists a record involving the user account and the device identification in the transactions; and
when determining that the record exists in the transactions, binding the user account and the device identification.

8. The apparatus according to claim 7, wherein the processor is configured to perform:
receiving a network access inquiry request sent from the terminal, wherein the network access inquiry request comprises the user account corresponding to the terminal and the device identification of the electronic device which requests to access a wireless network, and the wireless network is a network which the terminal has accesses;
determining whether there exists a record involving the user account and the device identification in the transactions; and
when there exists a record involving the user account and the device identification in the transactions, sending instruction information to the terminal, wherein the instruction information is configured to instruct enabling the electronic device to access the wireless network so that the terminal generates and sends the binding request.

9. The apparatus according to claim 7, wherein the processor is configured to store the record when a user conducts a transaction involving the electronic device and the user account.

10. The apparatus according to claim 7, wherein the user account comprises a login user account which is logged into in the terminal.

11. The apparatus according to claim 7, wherein the user account comprises a login user account which is input into the terminal by a user.

12. The apparatus according to claim 7, wherein the device identification of the electronic device is obtained by the terminal according to a network access request broadcast by the electronic device.

13. A non-transitory computer-readable storage medium having stored therein instructions that, when executed by a processor of a server, causes the server to perform acts comprising:
receiving a binding request sent from a terminal, wherein the binding request comprises a device identification identifying an electronic device and a user account corresponding to the terminal;
determining whether there exists a record involving the user account and the device identification in the server; and
when determining that the record exists in the server, binding the user account and the device identification.

14. The non-transitory computer-readable storage medium according to claim 13, wherein the acts further comprise:
receiving a network access inquiry request sent from the terminal, wherein the network access inquiry request comprises the user account corresponding to the terminal and the device identification of the electronic device which requests to access a wireless network, and the wireless network is a network which the terminal has accesses;
determining whether there exists a record involving the user account and the device identification in a record database; and
when there exists a record involving the user account and the device identification in the record database, sending instruction information to the terminal, wherein the instruction information is configured to instruct enabling the electronic device to access the wireless network so that the terminal generates and sends the binding request.

15. The non-transitory computer-readable storage medium according to claim 13, wherein the acts further comprising: storing the record when a user conducts a redemption involving the electronic device and the user account.

16. The non-transitory computer-readable storage medium according to claim 13, wherein the user account comprises a login user account which is logged into in the terminal.

17. The non-transitory computer-readable storage medium according to claim 13, wherein the user account comprises a login user account which is input into the terminal by a user.

18. The non-transitory computer-readable storage medium according to claim 13, wherein the device identification of the electronic device is obtained by the terminal according to a network access request broadcast by the electronic device.
